(19) United States
(12) Patent Application Publication
(10) Pub. No.: US 2022/0186160 A1
(43) Pub. Date: Jun. 16, 2022

(54) CLEANING FORMULATION

(71) Applicant: Linkage Technology Development Switzerland SA, Carouge GE (CH)

(72) Inventors: Libin SUN, Carouge GE (CH); Su YANG, Carouge GE (CH); Xinhan ZHU, Carouge GE (CH)

(73) Assignee: Linkage Technology Development Switzerland SA, Carouge GE (CH)

(21) Appl. No.: 17/199,011

(22) Filed: Mar. 11, 2021

(30) Foreign Application Priority Data
Dec. 16, 2020 (CN) 202011484638.9

(51) Int. Cl. C11D 17/06; C11D 11/00; C11D 1/14; C11D 3/12; C11D 3/10; C11D 3/37; C11D 3/20; C11D 3/33; C11D 17/00

(52) U.S. Cl. CPC C11D 17/06; C11D 11/0023; C11D 1/146; C11D 3/1246; C11D 17/0013; C11D 3/3749; C11D 3/2086; C11D 3/33; C11D 3/10

(57) ABSTRACT

The invention provides a method of cleaning a vehicle comprising: providing a powder composition; providing water; mixing the powder composition and the water to form a liquid cleaning formulation; and applying the liquid cleaning formulation to a surface of a vehicle, wherein the powder composition comprising: surfactant; silicate selected from magnesium lithium silicates and mixtures thereof; hygroscopic agent; at least 20 wt % carbonate salt; and at least 20 wt % acid.

### FIELD OF THE INVENTION

The present invention is directed to a cleaning method and to a formulation for use in the method and the production of this formulation.

### BACKGROUND OF THE INVENTION

Most cleaning formulations currently available on the market require the use of a large volume of additional water—for example, in order to make up a larger volume of cleaning solution, to dilute a concentrated cleaning solution, or to rinse off residues after a cleaning solution has been applied and used.

Clean water is a precious resource and a lack of clean water to meet demand is listed by the World Economic Forum as the largest global risk in terms of potential impact over the next decade.

In order to minimise this risk, there is a need to reduce the use and contamination of water in all kinds of processes. Cleaning is one area where large quantities of water are used and subsequently contaminated with various cleaning agents. This water must be cleaned before it can be used again. Vehicle cleaning (such as car cleaning) is a good example of an area where large quantities of water are used and contaminated with various chemical agents.

Formulations for waterless cleaning of vehicles have been put forward previously. “Waterless” cleaning means that only the cleaning formulation itself is used, and water is not required for rinsing. The formulation itself may contain water as solvent. Such formulations have not in general led to acceptable cleaning properties. In particular removal of dirt, shine of the final surface and storage stability have not generally been acceptable.

WO 2018/045925 A1 describes a formulation that cleans without need for additional water to dilute or rinse the cleaning formulation (i.e. a waterless cleaning formulation).

This formulation can pull dirt off a surface. It is not necessary to use additional water to rinse the dirt away. Water is thereby saved.

The applicant has found that cleaning formulations made according to this publication have room for improvement, in particular as regards their temperature stability.

WO2020/152299 describes an improved waterless cleaning formulation. This formulation is in liquid form and comprises solvent; silicate selected from magnesium lithium silicates and mixtures thereof; wherein silicate is present in a total amount in the range 0.01 to 1.5 wt %. This disclosure provides a waterless cleaning solution which has improved temperature stability. Such a cleaning solution can be shipped around the world or stored by consumers in most environments as well as used in different environmental conditions without fear of significant degradation or loss of efficacy.

The disclosure also provides improved viscosity profile, which renders the waterless cleaning formulation particularly effective. In particular the viscosity is desirably in a practical range for application by consumers, and the formulation has good spreadability at the same time a good cleaning and suspending properties.

The disclosure also aims to provide excellent cleaning properties including improved shine on the cleaned surface.

In addition, the solution does not require any additional water to carry out its cleaning function beyond that which may already be contained in the solution.

However, in order to produce the formulation it is necessary to mix and combine the ingredients with water. This can prove difficult and time-consuming. The ingredients are normally provided as powder. If water is added to the powder this leads to excessive agglomeration of the powder during the dissolution process by the formation of colloidal hydrates on the surface of the agglomerates. As the colloidal hydrate is dispersed, the viscosity of the system increases, but this makes dissolution generally slower. An alternative manner of mixing is to provide a bulk volume of water and add powder to that, but this tends to lead to the powder floating on the water and again taking longer to dissolve. For instance, it can take around four hours to completely dissolve the solid ingredients in water at 20° C.

The dissolution time can be reduced by using a higher water temperature, but this then increases energy use.

Furthermore, the difficulty in dissolving the powder ingredients means that they are unsuitable for supplying direct to consumers and instructing the consumers to dissolve the powder in water themselves. Accordingly, the formulation must be transported after making up the ingredients with water. It can be seen that the preferred liquid formulations in WO2020/152299 contain a high percentage of water. In the example formulations the level of water is greater than 99%. This increases transportation costs, likelihood of breakage during transport and decreases shelf-life.

Therefore it would be desirable to be able to provide a powder formulation which has improved dissolving properties. This would mean that dissolution by the manufacturer would be quicker and more energy-efficient and it can even mean that powder can be supplied to the consumer for addition to water by them. This form of supply would mean that transportation costs are reduced and that risk of breakage during transport is reduced and shelf-life is improved.

### SUMMARY OF THE INVENTION

According to the invention we provide in a first aspect a method of cleaning a vehicle comprising:

providing a powder;

providing water;

mixing the powder and the water to form a liquid cleaning formulation;

and applying the liquid cleaning formulation to a surface of a vehicle,

wherein the powder has a composition comprising:

surfactant;

silicate selected from magnesium lithium silicates and mixtures thereof;

hygroscopic agent;

at least 20 wt % carbonate salt; and

at least 20 wt % acid.

In a second aspect we provide a powder suitable for use in forming a liquid composition

for cleaning vehicle surfaces, the powder having a composition comprising:

surfactant;

silicate selected from magnesium lithium silicates and mixtures thereof;

hygroscopic agent;

at least 20 wt % carbonate salt; and

at least 20 wt % acid

In a third aspect we provide a method of making a liquid composition suitable for cleaning a vehicle surface, comprising mixing water and a powder composition comprising:

surfactant;

silicate selected from magnesium lithium silicates and mixtures thereof;

hygroscopic agent;

at least 20 wt % carbonate salt; and

at least 20 wt % acid.

Embodiments of the present invention include, but are not limited to, the following.

Embodiment 1. A method of cleaning a vehicle comprising:

providing a powder composition;

providing water;

mixing the powder composition and the water to form a liquid cleaning formulation;

and applying the liquid cleaning formulation to a surface of a vehicle,

wherein the powder composition comprising:

surfactant;

silicate selected from magnesium lithium silicates and mixtures thereof;

hygroscopic agent;

at least 20 wt % carbonate salt; and

at least 20 wt % acid.

Embodiment 2. A method according to embodiment 1 wherein the acid is citric acid, preferably anhydrous citric acid.

Embodiment 3. A method according to embodiment 1 or embodiment 2 wherein the carbonate salt is sodium carbonate.

Embodiment 4. A method according to any preceding embodiment wherein the hygroscopic agent is anhydrous betaine.

Embodiment 5. A method according to any preceding embodiment wherein the silicate comprises magnesium lithium silicate CAS #37220-90-9, preferably wherein the silicate consists essentially of magnesium lithium silicate CAS #37220-90-9.

Embodiment 6. A method according to any preceding embodiment wherein the surfactant comprises sodium dodecyl sulfate, preferably wherein the surfactant consists essentially of sodium dodecyl sulfate.

Embodiment 7. A method according to any preceding embodiment wherein the powder composition comprises oxidised polyethylene, preferably oxidised polyethylene CAS #68441-17-8, more preferably having an average molecular weight of from 1,000,000 to 2,000,000 Da.

Embodiment 8. A method according to any preceding embodiment wherein the powder composition comprises at least 25 wt % carbonate salt.

Embodiment 9. A method according to any preceding embodiment wherein the powder composition comprises at least 28% acid.

Embodiment 10. A method according to any preceding embodiment wherein the powder composition comprises at least 2 wt % hygroscopic agent.

Embodiment 11. A method according to any preceding embodiment, comprising the following steps: (a) providing a first microfiber cloth; (b) contacting the first microfiber cloth with the liquid liquid cleaning formulation; and (c) cleaning the surface by contacting the first microfiber cloth with a surface to be cleaned so as to apply the liquid cleaning formulation to the surface.

Embodiment 12. A method according to any preceding embodiment wherein the surface is an external surface of a vehicle

Embodiment 13. A method according to any preceding embodiment wherein the surface is an internal surface of a vehicle.

Embodiment 14. A powder composition suitable for use in forming a liquid composition for cleaning vehicle surfaces, the powder composition comprising:

surfactant;

silicate selected from magnesium lithium silicates and mixtures thereof;

hygroscopic agent;

at least 20 wt % carbonate salt; and

at least 20 wt % acid.

Embodiment 15. A powder composition according to embodiment 14 wherein the acid is citric acid, preferably anhydrous citric acid.

Embodiment 16. A powder composition according to embodiment 14 or embodiment 15 wherein the carbonate salt is sodium carbonate.

Embodiment 17. A powder composition according to any one of embodiments 14-16 wherein the hygroscopic agent is anhydrous betaine.

Embodiment 18. A powder composition according to any one of embodiments 14-17 wherein the silicate comprises magnesium lithium silicate CAS #37220-90-9, preferably wherein the silicate consists essentially of magnesium lithium silicate CAS #37220-90-9.

Embodiment 19. A powder composition according to any one of embodiments 14-18 wherein the surfactant comprises sodium dodecyl sulfate, preferably wherein the surfactant consists essentially of sodium dodecyl sulfate.

Embodiment 20. A powder composition according to any one of embodiments 14-19 wherein the powder composition comprises oxidised polyethylene, preferably oxidised polyethylene CAS #68441-17-8, more preferably having an average molecular weight of from 1,000,000 to 2,000,000 Da.

Embodiment 21. A powder composition according to any one of embodiments 14-20 wherein the powder composition comprises at least 25 wt % carbonate salt.

Embodiment 22. A powder composition according to any one of embodiments 14-21 wherein the powder composition comprises at least 28% acid.

Embodiment 23. A powder composition according to any one of embodiments 14-22 wherein the powder composition comprises at least 2 wt % hygroscopic agent.

Embodiment 24. A method of making a liquid composition suitable for cleaning a vehicle surface, comprising mixing water and a powder composition comprising:

surfactant;

silicate selected from magnesium lithium silicates and mixtures thereof;

hygroscopic agent;

at least 20 wt % carbonate salt; and

at least 20 wt % acid.

Embodiment 25. A method according to embodiment 24 wherein the ratio of water:powder composition is at least 90:10, preferably at least 95:5, more preferably at least 99:1.

Embodiment 26. A method according to embodiment 24 or 25 wherein the acid is citric acid, preferably anhydrous citric acid.

Embodiment 27. A method according to any one of embodiments 24-26 wherein the carbonate salt is sodium carbonate.

Embodiment 28. A method according to any one of embodiments 24-27 wherein the hygroscopic agent is anhydrous betaine.

Embodiment 29. A method according to any one of embodiments 24-28 wherein the silicate comprises magnesium lithium silicate CAS #37220-90-9, preferably wherein the silicate consists essentially of magnesium lithium silicate CAS #37220-90-9.

Embodiment 30. A method according to any one of embodiments 24-29 wherein the surfactant comprises sodium dodecyl sulfate, preferably wherein the surfactant consists essentially of sodium dodecyl sulfate.

Embodiment 31. A method according to any one of embodiments 24-30 wherein the powder composition comprises oxidised polyethylene, preferably oxidised polyethylene CAS #68441-17-8, more preferably having an average molecular weight of from 1,000,000 to 2,000,000 Da.

Embodiment 32. A method according to any one of embodiments 24-31 wherein the powder composition comprises at least 25 wt % carbonate salt.

Embodiment 33. A method according to any one of embodiments 24-32 wherein the powder composition comprises at least 28% acid.

Embodiment 34. A method according to any one of embodiments 24-33 wherein the powder composition comprises at least 2 wt % hygroscopic agent.

We find that the inclusion in the formulation of the defined high levels of carbonate and carboxylic acid mean that dissolution speed and efficiency are greatly increased. When the powder is contacted with water the acid and carbonate salt react to generate carbon dioxide gas and therefore effervescence. This greatly improves the dissolution process.

Using this powder it is possible to supply such a powder directly to the consumer for them to make u into the liquid formulation for use in cleaning the surface. As an example, 1.5 g of the powder ingredients other than carbonate and carboxylic acid can be blended with 1.5 g of sodium carbonate and 1.5 g of citric acid. This powder can be supplied to the consumer who mixes this blend with only 400 mL of water. Dissolution is rapid and efficient and the 400 mL of formulation is enough to clean the outside surface of an average car.

According to WO2020152299 it is possible to include citric acid in the composition in amounts suitable to adjust pH. It is also possible to include sodium carbonate in the formulation as a source of sodium ions. However, there is no suggestion of using the levels now described here in a powder composition in order to provide enhanced dissolution properties.

The field of application relates to vehicle surfaces and automotive maintenance preparations, namely detergents, polishing preparations, waxes, degreasers other than those used in manufacturing processes; automotive maintenance preparations, namely liquids and powders for cleaning, polishing and waxing treated automobile surfaces; preparations for cleaning and polishing automobile surfaces made of rubber, metal, plastic, leather, vinyl, textile, wood, glass, weather-resistant thermoplastic and velvet; all aforementioned goods used without water

Preferably the amount of powder used to form the liquid cleaning formulation is not more than 10 wt %, preferably not more than 5 wt %, more preferably not more than 1 wt %. It is preferred that the amount of powder is in the range 0.1 to 2 wt %, more preferably 0.2 to 1 wt %, of the final cleaning formulation. Most preferably it is not more than 0.8 wt %.

The remainder is water. Preferably the liquid cleaning formulation comprises greater than 95% water and more preferably greater than 99% water.

For cleaning one vehicle the amount of water is usually in the range 300 to 1000 mL, preferably 350 to 500 mL. Only 400 ml is needed to clean an ordinary car. If the volume made is more than 400 ml, the liquid cleaning formulation can also be stored in other non-sealable non-metal containers for future use.

The water can be any water available to the manufacturer or consumer, for instance bottled water, drinking water or natural water.

Any suitable mixing method may be used. Generally the user combines the powder and water in a container. Either the water or the powder can be added first.

The water temperature is preferably in the range 10 to 40 degrees C. Mixing time is preferably in the range 1 to 5 minutes. In general, a higher water temperature can allow a shorter mixing time for complete dissolution.

The carbonate salt is preferably sodium carbonate.

The amount of carbonate salt in the powder composition is at least 20 wt % and is preferably at least 25 wt %. In general it is not usually more than 35 wt %.

The acid is preferably citric acid, more preferably anhydrous citric acid. This has the advantage of forming sodium citrate on reaction with sodium carbonate. Sodium citrate is non-toxic, has pH adjusting performance and good stability. The content of metal ions such as Ca2+ and Mg2+ in untreated water is very high and so these can be present in the liquid cleaning formulation. The presence of sodium citrate is extremely beneficial for complexing such metal ions and improving the quality and stability of the liquid cleaning formulation.

The amount of acid in the powder composition is at least 20 wt % and is preferably at least 28 wt %. In general it is not usually more than 38 wt %.

When the carbonate salt and acid are sodium carbonate and citric acid, they react in the presence of water to form sodium citrate, carbon dioxide, and water.

It is desirable to prevent reaction between the carbonate salt and the acid before the liquid cleaning formulation is produced by mixing the powder with water. The generation of carbon dioxide gas causes the package to swell, and in severe cases it causes the package to rupture. In order to further ensure that the packaged powder bag does not contain moisture, it is necessary to include a hygroscopic agent in the powder composition to ensure the stability of the powder during storage.

The most preferred hygroscopic agent used is anhydrous betaine. Anhydrous betaine has good moisture absorption properties and is easily soluble in water. It is also widely used in cosmetics and food and is therefore considered safe for consumers.

The powder composition should be stored in a dry and dark place at an ambient temperature below 45° C., preferably 5-35° C., away from fire sources. Sealed shelf-life is two years.

The powder composition comprises silicate. In a particularly advantageous embodiment, the silicate is a magnesium lithium silicate, which has been found to exhibit thixotropic behavior and also meet the temperature stability and viscosity requirements.

The silicates generally have a layered structure.

Particularly preferable is that the silicate has the chemical formula Li2Mg2Si3O9. Also known as silicic acid, lithium magnesium salt, it has CAS #37220-90-9. This silicate gave the best balance of temperature stability, thixotropic and viscosity.

Silicates incorporating Na+, Li+, Mg2+ and Al3+ are contemplated.

Hectorite, CAS #12173-47-6 is also useful.

A further advantage of lithium magnesium silicates is that they are not irritating, they are safe and they are non-toxic. They also yield a transparent or highly translucent solution, which is favourable from a visual and aesthetic perspective.

The cleaning formulation should have a good balance between cleaning ability and usability—in other words, its viscosity should be neither too high nor too low. To achieve this, in some embodiments the silicate may be present in an amount of 1 wt % or less, preferably 0.5 wt % or less and most preferably 0.3 wt % or less relative to the liquid cleaning formulation.

In preferred embodiments, the silicate is present in the liquid cleaning formulation in an amount of at least 0.02 wt %.

A particularly desirable balance of viscosity and usability is achieved when the silicate is present in the liquid cleaning formulation in an amount between at least 0.02 wt % and up to 0.3 wt %.

In the powder composition the preferred level of silicate is in the range 4 to 30 wt %, preferably 10 to 25 wt %, more preferably 12 to 20 wt %.

It is highly preferred that the liquid cleaning solution be environmentally friendly and not contaminate existing water supplies. For this reason, it is highly advantageous if the powder composition contains no added phosphates. It is also desirable that the powder composition contain no added nitrates. Preferably, the powder composition contains no added amines. Equally, it is also preferable that the cleaning formulation does not contain highly nucleophilic compounds, such as nucleophilic sulphur species. Compounds such as alcohols are acceptable.

The powder composition comprises one or more surfactants. Surfactants allow the cleaning formulation to dissolve grease and oils present on a surface to be cleaned. The surfactant may be any surfactant generally known in the art.

Preferably, at least one surfactant has a hydrophilic-lipophilic balance of at least 20, preferably at least 30, and even more preferably at least 38. A surfactant which is highly soluble (having a greater hydrophilic-lipophilic balance) is advantageous for improving solubility of the powder composition.

In some embodiments, at least one surfactant is a water-soluble salt or acid of the formula ROSO3M, wherein R preferably is a C7-C24 hydrocarbyl, preferably an alkyl or hydroxyalkyl having a C7-C24 alkyl component, more preferably a C12-C18 alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof.

Advantageously, the formulation comprises sodium dodecyl sulfate as a surfactant. This is a readily available, highly water soluble and effective surfactant. It is also compatible with anionic and non-ionic surfactants. It has good performance in emulsification, permeation, cleaning and dispersion.

At least one surfactant may be a water-soluble salt or acid of the formula RO(A)mSO3X, wherein R is an unsubstituted C10-C24 alkyl or hydroxyalkyl group having a C10-C24 alkyl component, preferably a C12-C20 alkyl or hydroxyalkyl, more preferably C12-C18 alkyl or hydroxyalkyl, A is an ethoxy or propoxy unit, m is greater than zero, typically between about 0.5 and about 6, more preferably between about 0.5 and about 3, and X is H or a cation which can be, for example, a metal cation (e.g., sodium, potassium, lithium, calcium, magnesium, etc.), ammonium or substituted-ammonium cation.

Preferably, the surfactant is present in the liquid cleaning formulation in an amount between 0.05 and 0.075 wt %.

In the powder composition the preferred level of surfactant is in the range 2 to 20 wt %, preferably 5 to 15 wt %, more preferably 8 to 12 wt %.

In advantageous embodiments, the cleaning formulation may further comprise a polymer, preferably a polymer that is soluble and/or swellable in the solvent, such as carboxymethyl cellulose, and/or substituted/unsubstituted polyacrylate and/or polyether. Such a substance may perform a variety of functions.

It may act to further thicken the cleaning formulation, contributing to an increased viscosity. In this way, it may be possible to use a reduced amount of the silicate, for example.

It may also act as a flocculating agent, causing fine particulates to clump together and improving the cleaning ability of the cleaning formulation.

Another benefit may be that it improves the ability of the cleaning formulation to form a film over the surface that has been cleaned, which protects the surface and also provides a certain level of shine.

It may also act to reduce residual marks left by water, as the protective layer left behind by the cleaning formulation prevents these marks from forming.

The most preferred shining agent polymer is polyethylene, oxidised—CAS #68441-17-8. Oxidised polyethylene is beneficial because it is non-toxic, resistant to bacterial degradation and provides a visually pleasing (as well as protective) sheen after use. Oxidised polyethylene also has good temperature stability. When acting as a shining agent, oxidised polyethylene does not leave residual marks.

Carboxymethylcellulose is another example of a suitable polymer. Sodium carboxymethyl cellulose provides a homogeneous and stable emulsion. It plays the role of flocculation, chelation and emulsification, increases the lubrication degree (lubricity) of the cleaning solution, and allows the cleaning solution to be wiped more conveniently.

Preferably, polymer is present in the liquid cleaning formulation in an amount between 0.5 wt % and 0.1 wt %.

Where both carboxymethylcellulose and oxidised polyethylene are present in the cleaning formulation, favourable properties are obtained where carboxymethylcellulose is present in the liquid cleaning formulation in an amount between 0.05 wt % and 0.1 wt % and/or oxidised polyethylene is present in the liquid cleaning formulation in an amount between 0.01 wt % and 0.1 wt %.

In the powder composition the preferred level of polymer is in the range 0.5 to 10 wt %, preferably 1 to 7 wt %, more preferably 2 to 6 wt %.

A particularly favourable embodiment of the invention provides a powder composition according to the invention consisting essentially of:

lithium magnesium silicate hydrate or a silicate of formula H2LiMgNaO12Si4 (CAS #37220-90-9);

polyethylene, oxidised (CAS #68441-17-8);

M-dodecyl sulphate (preferably sodium dodecyl sulphate, CAS #151-21-3);

M-carbonate (preferably sodium carbonate, CAS #497-19-8);

M-citrate (preferably sodium citrate, CAS #77-92-9);

Betaine (preferably CAS #107-43-7)

wherein M is at least one type of counter ion.

A particularly favourable embodiment of the invention provides a method in which the powder composition is as above.

By “consisting essentially of” is meant that no other components are intentionally added. Small amounts of impurities may be present, but generally speaking, such a powder composition will contain only the above ingredients. In such a formulation, it is desirable if the only counter ion present in solution is essentially sodium. This means that besides impurities, no other counter ions are present or intentionally added. (It is noted that this does not mean that the silicate may only contain sodium ions.)

In other embodiments, the only counter ions present will be ones that do not have a disadvantageous effect on the cleaning ability of the cleaning formulation. For example, no “hard” ions will be present (where the word hard is understood to mean ions associated with hard water, such as calcium and magnesium. This does not apply to the silicate itself in cases where the silicate itself contains magnesium or calcium ions).

It is acceptable for other additives to be present in the solution as an additional thickener or lubricity agent. Examples of other additives that are acceptable additional viscosity increasing agents are montmorillonite (organic bentonite), hectorite, fumed silica, methyl cellulose, hydroxypropyl methylcellulose, hydroxyethyl cellulose, polyvinypyrrolidone, polyvinylalcohol, polyacrylamide, polyethylene wax, (sodium) polyacrylate, polyurethane and polyethylene oxide. Of these, the additives that have most beneficial temperature stability are Montmorillonite (organic bentonite), fumed silica, polyvinyl alcohol, polyvinyl pyrrolidone, polyethylene oxide, polyurethane and polyethylene wax. The cleaning formulation may additionally comprise one or several of these compounds.

The cleaning formulation may comprise an additional shining agent. This is a substance that is able to produce a shine or sheen on a surface. Shine on a surface typically arises in that a substance is able to fill in small gaps, scratches, cracks or holes on the surface, thereby making the surface smoother. A smoother surface reflects light more consistently and therefore appears shinier. A shining agent will therefore be a substance that can achieve this result.

One example of an additional shining agent is a wax.

Alternatively or additionally, the shining agent may comprise a salt or acid, for example a sodium salt, of a substituted or unsubstituted alkyl carboxylate, wherein the number of carbon atoms in the alkyl chain is between 16 and 22, preferably between 17 and 19, more preferably 18.

The alkyl carboxylate may be substituted with at least one additional hydrophilic group, for example a hydroxy group, preferably at one or more of carbons 11, 12 and/or 13, most preferably carbon 12. In particular, the alkyl carboxylate may be 12-hydroxyoctadecanoate, preferably the sodium salt thereof.

Certain properties of the liquid formulation once it has been made up from the powder composition and the water are advantageous, as follows.

In general it is important that the viscosity of the liquid cleaning formulation be greater than that of water. This enables the cleaning formulation to pull sufficient amounts of dirt from the dirty surface.

At the other end of the scale, it is advantageous when the viscosity of the liquid cleaning formulation is not too high, otherwise the user may find it difficult to work with the cleaning formulation. The applicant has found that preferably, the cleaning formulation will have a viscosity of up to 100 mPa·s, more preferably up to 75 mPa·s, and most preferably up to 45 mPa·s. In this way, a balance is achieved between the cleaning ability of the formulation and its usability.

A particularly preferred viscosity range for the cleaning formulation is between 28 mPa·s and 45 mPa·s.

For the present invention, the viscosity of a liquid cleaning formulation will be that measured at around 20° C. It is most advantageous if a suitable viscosity is achieved for all temperatures at which the cleaning formulation might be expected to be used. For water-based cleaning formulations, this will usually be in the temperature range from −20° C. up to around 60° C., although narrower ranges within which the suitable viscosity is achieved are also acceptable, such as 0° C. to 50° C., or 5° C. to 35° C. The point is that the cleaning formulation has the required viscosity when the user goes to use it.

It is advantageous that the liquid cleaning formulation be thixotropic, or exhibit thixotropic behavior, at least in the temperature range at which the cleaning formulation will typically be used.

A further aspect of the invention provides a method of cleaning a surface, the method comprising the following steps:

providing the liquid cleaning formulation by means of the method of the first aspect of the invention;

applying the undiluted cleaning formulation to the surface.

Preferably the method comprises the following steps:

providing a first microfiber cloth;

contacting the first microfiber cloth with the undiluted liquid cleaning formulation;

and cleaning the surface by contacting the first microfiber cloth with a surface to be cleaned so as to apply the undiluted cleaning formulation to the surface.

Preferably the method further comprises:

providing a second microfiber cloth rubbing the surface using the second microfiber cloth so as to remove the cleaning formulation and polish the surface to be cleaned.

In the method the first microfiber cloth and the second microfiber cloth comprise fibres, each fibre preferably comprising between 100 and 150 fibrils., preferably wherein the fibres have a widest diameter of between 0.2 and 1 micrometres.

The surface is a hard surface and preferably comprises metal, ceramic, enamel, varnished or sealed surfaces, painted surfaces, plastic, leather, glass or wood.

Preferably the surface is an external surface of a vehicle such as a car.

However, the surface can be an internal surface of a vehicle.

The use of a microfiber cloth has several special advantages.

Firstly, such a cloth is especially soft and will not scratch the surface that is being cleaned. This is especially important when the surface is the paintwork of a car, for instances.

Secondly, the microfibers of the cloth (as opposed to the “macrofibres” of a standard, non-microfiber cloth) facilitate the capture of dirt, grit and sand particles. The tiny fibres are able to bury the parties deep within the cloth structure. This enables the effective removal of dirt and also prevents dirt escaping, such that it can either be deposited back onto the clean surface or be dragged along the surface by the cloth and scratch it.

Thirdly, it is believed that the microfibers facilitate an electrostatic interaction between the cleaning solution and the fibres. This further improves the ability of the cloth to lift dirt from the surface to be cleaned.

The method may comprise the additional step of removing the cleaning formulation and polishing the surface using a second microfiber cloth directly after contacting the first microfiber cloth with the surface to be cleaned. In this way, the cleaning solution is not left to sit on the surface—instead, the solution and encapsulated dirt is quickly removed. This reduces unnecessary loss of the cleaning solution through evaporation. It also allows contemporaneous shining or buffing of the surface, such that this does not have to follow in a separate step or with a separate shining formulation.

A favourable microfiber cloth construction is one wherein the first microfiber cloth and the second microfiber cloth comprise fibres, each fibre comprising between 100 and 150 fibrils, preferably wherein the fibres have a widest diameter of between 0.2 and 1 micrometres. Such a cloth has increased surface area of the fiber (up to 50 times greater than a normal towel), which increases the porosity in the fabric. This allows rapid and significant absorption of the cleaning solution.

The microfiber cloth preferably is composed of around 80% dacron (polyethylene terephthalate), which is strong, and 20% chinlon (a type of nylon), which is highly absorbent.

A container in which the powder formulation is held, and one or more cloths as discussed above, can be provided as a kit.

### Example According to Invention

According to the experimental results, the preferred amounts are 1.5 grams of sodium carbonate and 1.8 grams of citric acid added to 1.5 g of other powder ingredients.

The sodium carbonate, and anhydrous citric acid, and the remaining powder ingredients, were placed in an oven at 80° C. for 24 hours to reduce the water content. The composition was mixed and sealed in bags. The composition was as below, with possible ranges also shown.

| | | Amount in g |
|---|---|---|
| Component | CAS# | (preferred range) |
| Lithium magnesium | 37220-90-9 | 0.8 g (0.2-1.5 g) |
| silicate hydrate | | |
| Polyethylene, Oxidized | 68441-17-8 | 0.2 g (0.1-0.5 g) |
| Sodium dodecyl sulfate | 151-21-3 | 0.5 g (0.1-1. g) |
| Sodium Carbonate | 497-19-8 | 1.5 g (0.5-2 g) |
| Citric Acid | 77-92-9 | 1.8 g (0.6-2.4 g) |
| Betaine Anhydrous | 107-43-7 | 0.2 g (0.1-0.5 g) |
| Water | 7732-18-5 | 995 g (998.4-992.1 g) |

The required amount of water was prepared; the powder was poured into a container, and the specified amount of water was added at one time. After 3-5 minutes the liquid became completely transparent. The presence of foam was seen and is normal and does not affect use.

1. A method of cleaning a vehicle comprising:
providing a powder composition;
providing water;
mixing the powder composition and the water to form a liquid cleaning formulation;
and applying the liquid cleaning formulation to a surface of a vehicle,
wherein the powder composition comprising:
surfactant;
silicate selected from magnesium lithium silicates and mixtures thereof;
hygroscopic agent;
at least 20 wt % carbonate salt; and
at least 20 wt % acid.

2. A method according to claim 1 wherein the acid is citric acid, preferably anhydrous citric acid.

3. A method according to claim 1 wherein the carbonate salt is sodium carbonate.

4. A method according to claim 1 wherein the hygroscopic agent is anhydrous betaine.

5. A method according to claim 1 wherein the silicate comprises magnesium lithium silicate CAS #37220-90-9, preferably wherein the silicate consists essentially of magnesium lithium silicate CAS #37220-90-9.

6. A method according to claim 1 wherein the surfactant comprises sodium dodecyl sulfate, preferably wherein the surfactant consists essentially of sodium dodecyl sulfate.

7. A method according to claim 1 wherein the powder composition comprises oxidised polyethylene, preferably oxidised polyethylene CAS #68441-17-8, more preferably having an average molecular weight of from 1,000,000 to 2,000,000 Da.

8. A method according to claim 1 wherein the powder composition comprises at least 25 wt % carbonate salt.

9. A method according to claim 1 wherein the powder composition comprises at least 28% acid.

10. A method according to claim 1 wherein the powder composition comprises at least 2 wt % hygroscopic agent.

11. A method according to claim 1, comprising the following steps: (a) providing a first microfiber cloth; (b) contacting the first microfiber cloth with the liquid liquid cleaning formulation; and (c) cleaning the surface by contacting the first microfiber cloth with a surface to be cleaned so as to apply the liquid cleaning formulation to the surface.

12. A method according to claim 1 wherein the surface is an external surface of a vehicle

13. A method according to claim 1 wherein the surface is an internal surface of a vehicle.

14. A powder composition suitable for use in forming a liquid composition for cleaning vehicle surfaces, the powder composition comprising:
surfactant;
silicate selected from magnesium lithium silicates and mixtures thereof;
hygroscopic agent;
at least 20 wt % carbonate salt; and
at least 20 wt % acid.

15. A powder composition according to claim 14, wherein the acid is citric acid.

16. A method of making a liquid composition suitable for cleaning a vehicle surface, comprising mixing water and a powder composition comprising:
surfactant;
silicate selected from magnesium lithium silicates and mixtures thereof;
hygroscopic agent;
at least 20 wt % carbonate salt; and
at least 20 wt % acid.

17. A method according to claim 16 wherein the ratio of water:powder composition is at least 90:10, preferably at least 95:5, more preferably at least 99:1.

18. A method according to claim 16, wherein the acid is citric acid.

19. A method according to claim 2 wherein the carbonate salt is sodium carbonate.

20. A method according to claim 2 wherein the hygroscopic agent is anhydrous betaine.
